(19) United States
(12) Patent Application Publication
(10) Pub. No.: US 2022/0092452 A1
(43) Pub. Date: Mar. 24, 2022

(54) AUTOMATED MACHINE LEARNING TOOL FOR EXPLAINING THE EFFECTS OF COMPLEX TEXT ON PREDICTIVE RESULTS

(71) Applicant: TIBCO Software Inc., Palo Alto, CA (US)

(72) Inventors: Gaia Valeria PAOLINI, Palo Alto, CA (US); Daniel ROPE, Palo Alto, CA (US); Tun-Chieh HSU, Palo Alto, CA (US); Noora HUSSEINI, Palo Alto, CA (US); Michael O'CONNELL, Palo Alto, CA (US)

(21) Appl. No.: 17/396,340

(22) Filed: Aug. 6, 2021

Related U.S. Application Data
(60) Provisional application No. 63/080,541, filed on Sep. 18, 2020.

(51) Int. Cl. G06N 5/04; G06F 40/216; G06N 7/00; G06N 20/00

(52) U.S. Cl. CPC G06N 5/045; G06N 20/00; G06N 7/005; G06F 40/216

(57) ABSTRACT

An apparatus comprising feature engineering and text explanation modules for explaining text from predictive results of an algorithmic model. The feature engineering module creates vectors for string variables, each string variable comprising identified text, each vector created comprising a numeric combination, each numeric combination identifying a variable name and a value having a word or a phrase. The feature engineering module causes a predictive engine to generate predictive results using the algorithmic model, the data set, and the vectors created. The predictive results comprising the string variable or a modified version of the string variable and a confidence score. The text explanation module maps words and phrases from qualified text of the string variable, or modified version, to the numeric combinations of the vectors and determines a probability score for each word and each phrase. The most influential words and phrases are plotted on a chart.

### CROSS REFERENCE TO RELATED APPLICATION

This application claims priority to U.S. Provisional Patent Application No. 63/080,541, filed Sep. 18, 2020, entitled “An Automated Machine Learning Tool for Learning and Explaining Text Input,” the entire contents of which are hereby fully incorporated herein by reference for all purposes.

### BACKGROUND

Automated Machine Learning (AutoML) is a research and technical development area dedicated to making ML more accessible, improve efficiency of ML systems, and accelerate research and application development. AutoML based applications are developed to address real-world problems and are built to automate many base data processing and predictive analysis functions of data sets using Machine Learning (ML) algorithmic models. The solutions can include data pre-processing and cleaning functions, feature selection functions, algorithmic model selection functions, and model execution and analysis functions. AutoML applications are industry and business specific applications that provide an excellent means by which a targeted software solution can be developed in order to improve a data scientist's productivity and provide enhanced data analytics capabilities. An industry or company can gain valuable insights gleaned from these types of applications, such as providing previously, unseen or not understood insight of an operations assets in a supply chain or providing analysis and predictive results used to identify potential malfunctions of components in a complex system, such as semi-conductor manufacturing operations.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a diagram of a feature engineering module, a predictive engine module, and a text explain-ability module for generating predictive results and explanations of the effect a text variable has on predictive results, in accordance with certain example embodiments;

FIG. 2 is an illustration of a dataset comprising string variables having variable names and values associated therewith, in accordance with certain example embodiments;

FIG. 3 is an illustration of a flow chart of an algorithm of the text detection component for detecting text in a data source, in accordance with certain example embodiments;

FIG. 4 is an illustration of example rule sets and metadata generated by the algorithm of the text detection component based on a postulated metric, in accordance with certain example embodiments;

FIG. 5 is an illustration of an algorithm for the automated, hyper-parameter setting feature that is used to estimate a hyper-parameter setting by postulating a metric and evaluating the metric against a number of text corpus in order to determine an adequate number of vectors for use in the text feature engineering module, in accordance with certain example embodiments;

FIG. 6 is an illustration of results of a functional form applied against multiple test datasets and used to evaluate a postulated metric, the metric used to determine a suitable number of vectors for use with the automated, hyper-parameter setting feature, in accordance with certain example embodiments;

FIG. 7 is an illustration of an algorithm of the text explain-ability component, used to enhance the functionality of the string explain-ability component, for generating an explanation of the effect text variables have on predictive results of the predictive engine, in accordance with example embodiments;

FIG. 8 is an illustration of a diagram depicting the functional features of the text explain-ability component, wherein constituent words from a classified, assembled text variable having a score of 0 are mapped to their original vector and constituent words from another classified, assembled text variable having a score of 1 are mapped to their original vector and, then, further processed through a filter, in accordance with example embodiments;

FIG. 9 is an illustration of a diagram depicting functional features of the text explain-ability component, in accordance with example embodiments;

FIG. 10 is an illustration of a chart and 2D plot of words in a first vector having a first classification and words in a second vector having a second classification, wherein the words have a probability score greater than a pre-defined threshold, in accordance with example embodiments; and

FIG. 11 is an illustration of a computing machine and a system applications module, in accordance with example embodiments.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

Application developers rely on the AutoML system architecture to develop applications for the purpose of training data scientists, boosting productivity of the data scientist, and improving, such as making more efficient, accurate, or both, an algorithmic model's predictive capabilities. As a tool used for these purposes, application developers that develop solutions based upon the AutoML system architecture typically rely upon functional features provided by the AutoML system architecture and enhance one or more of these functional features. As previously discussed, the AutoML system architecture includes the following functional components: data pre-processing and cleaning functions, feature selection functions, algorithmic model selection functions, and model execution and analysis functions. A key functional feature considering the purpose of the applications developed is the model execution and analysis functions.

The model execution and analysis functions of the current state of the art of the AutoML system architecture is severely limited in its capabilities of providing proper analysis of an algorithmic model, its predictive results, and a variable's influence on the algorithmic models and its predictive results when executed against a dataset. The current state of the art AutoML system architecture and other known solutions that rely upon the AutoML system architecture are limited in their verbosity with respect to the analysis of the algorithmic model's execution against a dataset and the influence of particular variables on the predictive results. This limitation greatly affects the effectiveness of an application developed for the purpose of training data scientist, boosting productivity of the data scientist, and improving an algorithmic model's predictive capabilities.

The existing AutoML system architecture and other known solutions can be greatly enhanced by combining traditional quantitative data with ‘free-form’ text data, such as, for instance, user reviews. Some AutoML offerings can produce models that include information from categorical variables made of simple strings. Stated differently, some AutoML offerings can produce algorithmic models that include information from string variables that are defined as categorical. Some AutoML offerings can provide some insight into the model's decisions, quality and relevance. This insight, or ‘model explainability’, is becoming an important discriminating feature in AutoML systems. However, the existing state-of-the-art AutoML does not provide an insight into the model behaviors when the input data includes text that is free-form, dynamic, and complex, i.e. beyond categorical. In order to provide needed verbosity, the data pre-processing and cleaning functions, feature selection functions, and model execution and analysis functions of the existing AutoML system architecture needs to be improved.

Presented herein is an apparatus for identifying text and explaining text from predictive results generated by at least one algorithmic model. The apparatus comprises a feature engineering module and a text explanation module. The feature engineering module is configured to create a plurality of vectors for at least one string variable, with each string variable comprising identified text, each vector created comprising a numeric combination, each numeric combination identifying a variable name and at least one selected from a group comprising a value having a word and another value having a phrase; and causing a predictive engine to generate predictive results using the at least one algorithmic model, the data set, and the vectors created, the predictive results comprising the at least one string variable or a modified version of the at least one string variable and at least one confidence score associated with the at least one string variable or the modified version of the at least one string variable. The text explanation module is configured to: map at least one selected from a group comprising words and at least one phrase from qualified text of the at least one string variable to the numeric combinations of the vectors; determine a probability score for each word and each phrase; and generate chart variables and plot variables, the plot variables comprising at least one of selected from a group comprising the most influential words and the most influential phrases, the most influential words and phrases based on the probability scores.

Presented herein is a system for identifying text and explaining text from predictive results generated by at least one algorithmic model. The system comprises a feature engineering module, a predictive engine module, and a text explanation module. The feature engineering module is configured to create a plurality of vectors for at least one string variable, with each string variable comprising identified text, each vector created comprising a numeric combination, each numeric combination identifying a variable name and at least one selected from a group comprising a value having a word and another value having a phrase. The predictive engine module is configured to generate at least one predictive result using the at least one algorithmic model, the data set, and the vectors created, the predictive results comprising the at least one string variable or a modified version of the at least one string variable and at least one confidence score associated with the at least one string variable or the modified version of the at least one string variable. The text explanation module is configure to: map at least one selected from a group comprising words and at least one phrase from qualified text of the at least one string variable to the numeric combinations of the vectors; determine a probability score for each word and each phrase; and generate chart variables and plot variables, the plot variables comprising at least one of selected from a group comprising the most influential words and the most influential phrases, the most influential words and phrases based on the probability scores.

In an embodiment of the apparatus and system, the predictive engine can generate the at least one predictive result based on an outcome variable using the at least one algorithmic model, the at least one predictive result comprising the at least one string variable and the at least one confidence score. Additionally, the apparatus and system comprises a text detection module configured to: determine the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and the one or more sentences and the one or more paragraphs comprising at least one selected from a group comprising a plurality of words and at least one phrase. Furthermore, the set of rules can be a-priori information, the set of rules determined based on a metric, the metric defining a minimal length of text and variability of at least one selected from a group comprising words and phrases, and variable names or variable metadata. In addition, the feature engineering module can be configured to determine a number of vectors for the identified text. The number of vectors can be a-priori information. The number of vectors for the identified text can be determined based on at least one text corpus and a functional form. Additionally, the text explanation module can be configured to determine qualified text based on the at least one confidence score. Finally, the probability score can be determined using Bayes' theorem for each word and for each phrase.

Also presented herein is a method for identifying and explaining text from predictive results generated by at least one algorithmic model. The method comprises creating a plurality of vectors for at least one string variable, with each string variable comprising identified text, each vector created comprising a numeric combination, each numeric combination identifying a variable name and at least one selected from a group comprising a value having a word and another value having a phrase; generating at least one predictive result using the at least one algorithmic model, the data set, and the vectors created, the predictive results comprising the at least one string variable or a modified version of the at least one string variable and at least one confidence score associated with the at least one string variable or the modified version of the at least one string variable; mapping at least one selected from a group comprising words and at least one phrase from qualified text of the at least one string variable to the numeric combinations of the vectors; determining a probability score for each word and each phrase; and generating chart variables and plot variables, the plot variables comprising at least one of selected from a group comprising the most influential words and the most influential phrases, the most influential words and phrases based on the probability scores.

In an embodiment, the method also comprises determining the identified text. The identified text can be determined based on at least one selected from a group comprising a set of rules and a minimal confidence score. The identified text includes at least one variable name associated with a variable of the data set and a variable value comprising at least one selected from a group comprising one or more sentences and one or more paragraphs. The one or more sentences and the one or more paragraphs comprising at least one selected from a group comprising a plurality of words and at least one phrase. Additionally, the set of rules can be a-priori information. The set of rules can be determined based on a metric. The metric defining a minimal length of text and variability of at least one selected from a group comprising words and phrases, and variable names or variable metadata. In addition, the method further includes determining a number of vectors for the identified text. The number of vectors for the identified text can be determined based on at least one text corpus and a functional form. Furthermore, the method also includes determining qualified text based on the at least one confidence score. In addition, the method can also include determining the probability score using Bayes' theorem for each word and for each phrase. Additionally, the method can include generating the at least one predictive result based on an outcome variable using the at least one algorithmic model. The at least one predictive result comprising the at least one string variable and the at least one confidence score.

The term text or free text used herein is a term used to describe an entry of a variable value or entries of a variable value that are considered more complex than string variables that are categorical and satisfy a set of rules for determining when an entry or entries behave like text. The term hyper-parameter used herein means a number of vectors that are to be generated when applying a Word2vec (natural language processing) to an entry of a text variable or entries of a text variable. In general, it means all the parameters in a machine-learning algorithm that are not fixed by training the algorithm on the data but must be specified a-priori to control the learning process itself. The term stop word used herein is a word that is not relevant to text mining but represents common words used in a sentence, e.g. and, for, by, however, when, in, out etc. These words are normally filtered out when processing a piece of text. The term vector as used herein is a numeric representation of a variable that includes one or more words, one or more phrases, or both and several identifiers and a label that can be used to identify a word, words, or phrase as being part of a complex string structure, i.e. text, a dataset, a variable of the dataset, a variable name, a row of the variable, associated algorithmic models, and test datasets. Although, other identifiers are possible.

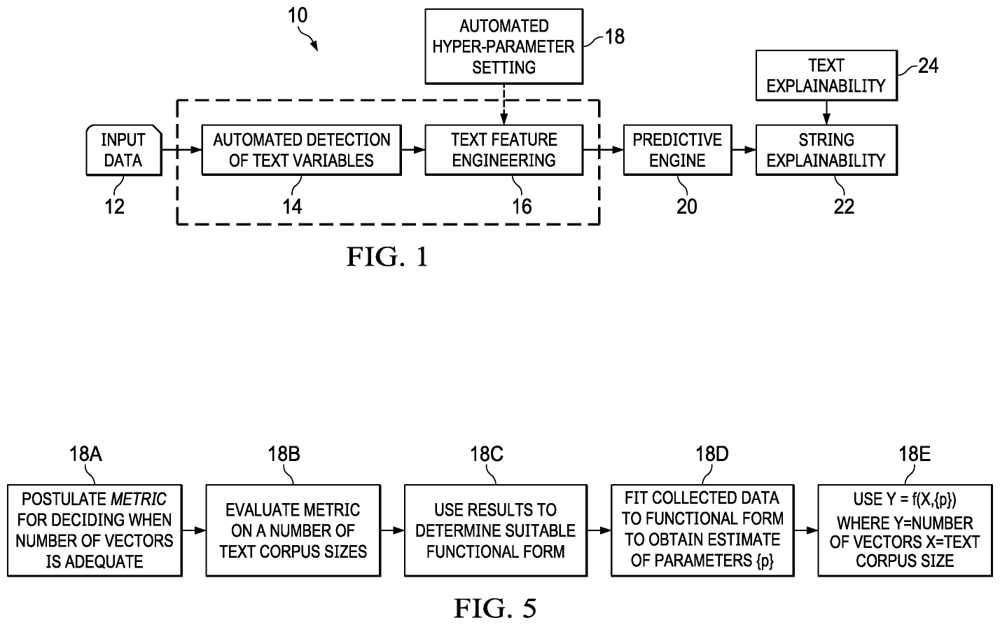

Referring now to FIG. 1, illustrated is a diagram of a feature engineering module 10, a predictive engine module 20, and a text explain-ability module 24 for generating predictive results and an explanation of an effect a text variable has on predictive results, in accordance with example embodiments. The feature engineering module 10, the predictive engine module 20, and the text-explain-ability module 24 function in a cooperative manner to automatically generate an algorithmic model, generate predictive results based on one or more outcome variables and one or more predictor variables, and automatically generate an explanation of text and the effects of the text on the predictive results. As previously mentioned, a variable comprising text can be considered a complex string structure. A complex string structure can be defined as being less predictable and less structured, e.g., a variable comprising a string that is considered categorical. It is a structure that cannot be effectively interpreted by existing. That is to say, although the predictive engine module 20 can provide an explanation of the effects of a string variable on predictive results, existing predictive engine technology is limited to, e.g., string variables that are considered categorical or otherwise have a limited value range.

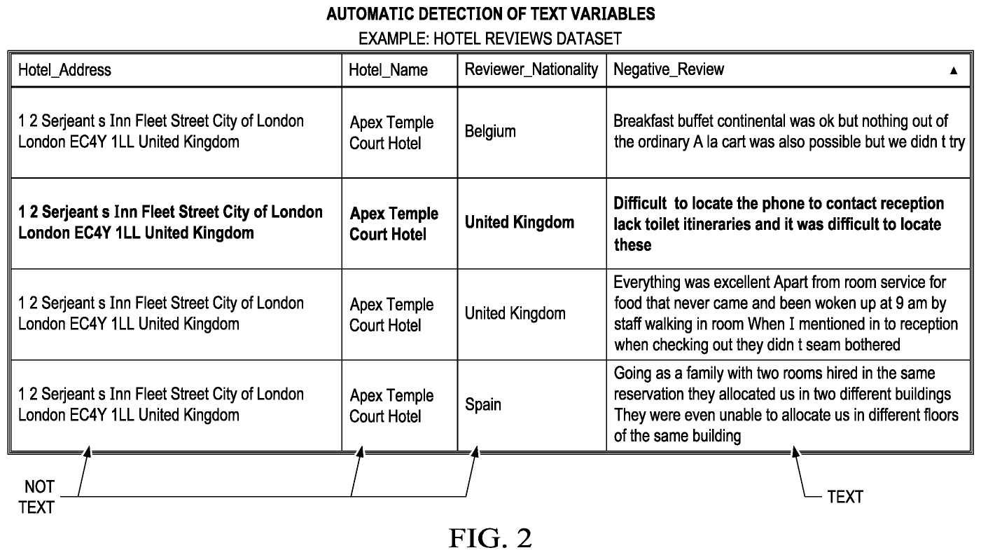

FIG. 2 is an illustration of a dataset comprising string variables having names and values associated therewith, in accordance with example embodiments. In the case of the “Hotel_Address,” “Hotel_Name,” and “Reviewer_Nationality” names, the values are not considered text and are values that existing AutoML machinery is capable of providing explanation as to how the values affect predictive results. It can be easily discerned that the values associated with these variable names are categorical and are of a limited value range or otherwise limited value data structure. With respect to the “Negative Review” name, the values are comments based on the subjective analysis of a viewer. It is this type of string variable that existing AutoML machinery, or the like, is incapable of or ineffective at providing explanation as to how the values affect the predictive results.

Returning to FIG. 1, the feature engineering module 10 comprises a text detection component 14 and a text feature engineering component 16. The text feature engineering component 16 has an automated, hyper-parameter setting feature 18. This feature is an enhancement of the text feature engineering component 16 and will be discussed in greater detail. The feature engineering module 10 is communicably coupled to a data source 12. The data source 12 can comprise a plurality of input variables and variable types, such as a character, string, numeric, date/time, Unicode character and string, and binary. An example data source 12 can comprise web based content, such as generated merchant or merchant product reviews. The plurality of input variables can be stored in a central data repository or a distributed data repository. The feature engineering module 10 is communicably coupled to the predictive engine module 20. The predictive engine module 20 comprises a string explain-ability component 22. A text explain-ability component 24 is communicably coupled to the string explain-ability component 22 to augment the explain-ability component 22 of the AutoML machinery.

It should be understood, with respect to FIG. 1, the text feature engineering component 16, the predictive engine module 20, and the string explain-ability component 22 are parts of existing machinery, e.g. AutoML, that are being enhanced by augmenting the functionality in order to explain the effects of text on predictive results generated by the machinery. The augmentation can be broken up into three sections, an automated text detection process, an automated hyper-parameter setting process, and a text explain-ability process.

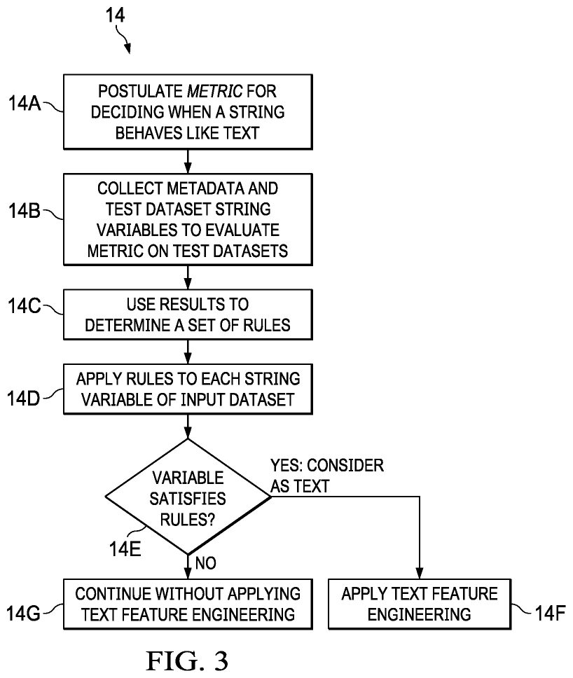

Referring now to FIG. 3, illustrated is a flow chart of an algorithm of the text detection component 14 for detecting text in the input data source 12, in accordance with example embodiments. The algorithm functions to provide variables from the input data source 12 to the text feature engineering component 16. It should be understood that the text feature engineering component 16 is a subcomponent of the predictive engine 20. As previously discussed, the predictive engine 20 can be a commercially available AutoML implementation. However, existing solutions are inadequate or incapable of explaining complex string structures. Current solutions are only capable of providing an explanation of simple string variables that are, e.g., categorical. The algorithm of the text detection component 14 enhances this functionality of the string explainability component 22 by generating a set of rules that are used to identify complex string variables, i.e. text, and associate additional information with the variables so that text associated with variable values can be deconstructed into constituent words, scored, reconstructed into text, scored again, and interpreted to describe the effect that text, words of the text, or both have on predictive results. The output of the algorithm of the text detection component 14 can include both simple string variables and complex strings variables where the complex structures are identified by a set of rules and labeled.

The algorithm begins at block 14A where a metric from a grouping of postulated metrics is selected based on variable name or names of a dataset or datasets. The postulated metric selected is used in deciding if a string value or values behave like text. The metric is chosen to capture the length, variability, or any combination thereof of free text. Alternatively, the user can choose not to use the postulated metric but rather select which variable or variables from a data set or select which values of a variable or variables can be considered text. The algorithm continues as block 14B. A heuristic model is used to evaluate the metric on a test dataset or test datasets. As an example, the variable value setting can be for a variable name in a classification based algorithmic model. The algorithm continues at block 14C. Metadata and string variables generated as a product of evaluating the metric on the test dataset or datasets is used to determine a set of rules. At block 14D, the algorithm applies the set of rules to each string variable of an input dataset from the input data source 12. At block 14E, the algorithm determines if a string variable satisfies the rule. If the variable satisfies the rule, the algorithm identifies the string variable and continues processing by applying text feature engineering, block 14F. If the variable doesn't satisfy the rule, the algorithm continues without applying text feature engineering by applying other rules to string variables, block 14G.

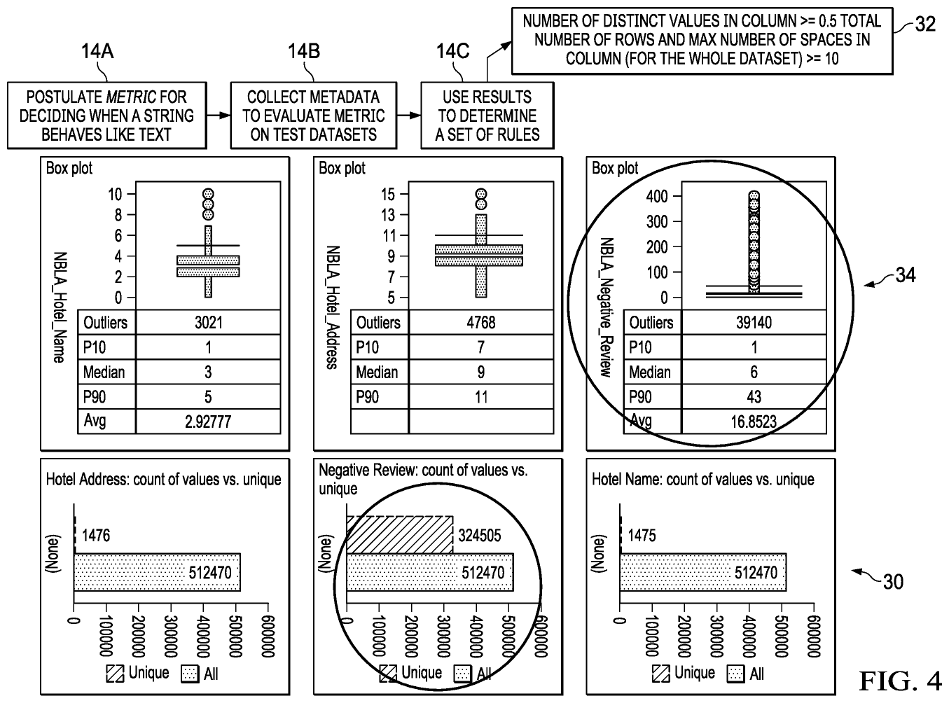

Referring now to FIG. 4, illustrated are example rule sets and metadata generated by the algorithm of the text detection component 14 based on a postulated metric, in accordance with example embodiments. As previously stated, the metric is chosen to capture the length, variability, grammatical structure, or any combination thereof of free text. As an example, a string variable may have a variable name, such as hotel reviews, and multiple entries (rows), such as reviewer 1 comments . . . reviewer n comments, associated with that variable name. An example metric used by the text detection component 14 to determine whether an entry and/or entries for a variable value should be considered text is that actual text, as opposed to a string that is considered categorical, has high variability in sentence length and number of words when considering an individual entry and/or a grouping of entries. In contrast, a string variable may have a variable name, such as “pets allowed,” and multiple entries, such as a binary value of “true” or “false” or “yes” or “no,” associated with that variable name. In this particular case, the values associated with the variable name are categorical and not considered actual text. Furthermore, the metric postulated could be based on the number of unique words and/or the number of repetitive words per entry and/or per grouping of entries. Additionally, a metric used by the text detection component 14 could be that a particular number of blanks, particular number of punctuation marks, and/or a particular number of capital letters can be used to determine whether an entry or entries for a string variable is actual text or a simple string. Another metric that could be used alone is the actual variable name, such as “user reviews” or “user comments” or “pets allowed,” of the variable. Obviously, any combination of the metrics can be used as a mechanism to determine if an entry or entries in a variable qualify as text. As previously stated, actual text has high variability in sentence length and number of words when considering an individual entry and/or a grouping of entries. However, determining the lower limit can be challenging. As such, a combination of particular metrics can be used to determine this lower limit.

Charts 30 are example charts illustrating generated metadata generated by the text detection component 14 based on a postulated metric and a dataset comprising string variables. The charts include a first variable name value “Hotel Address,” a second variable name value “Negative Review,” and a third variable name value “Hotel Name.” Associated with each variable name is a total count of words within a variable value or variable values (entries or rows) and unique words in variable values. From the charts 30, or rather metadata therefrom, the text detection component 14 can determine a set of rules 32.

Charts 34 are example charts illustrating additional analysis performed by the text detection component 14 to formulate the set of rules 32. A probability distribution function can be used to determine the variability of words in a row and/or rows of a variable name, such as “NBLA_Hotel_Name.” The text detection component 14 can identify the variability in the form of outliers, percentage points, median, and average. The number of outliers is indicative of the variability of words in an entry and/or entries, which can also be indicative of length of a particular entry and, therefore, indicative of whether an entry is a binary entry (categorical: yes/no), a sentence, or a paragraph. The probability distribution function can be used to determine the median value, which takes into account the number of outliers. As can be seen, the distribution of values in the third box plot strongly indicates that an entry and/or entries associated with a variable should be considered actual text. A grouping of entries where the individual entries are considered repetitive are often not considered text. The first two charts of charts 34 indicate a tight clustering of range and, therefore, are more likely not to be considered actual text. It should be understood that threshold values for the outliers, the percentage points, median, and average can be set in order to dictate when entries behave like actual text. It should also be understood that metrics can be postulated so that the set of rules applies to the variable as a whole.

Referring now to FIG. 5, illustrated is an algorithm for the automated, hyper-parameter setting feature 18 of the featuring engineering module 10 for estimating a hyper-parameter setting by postulating a metric and evaluating the metric against a number of text corpus, i.e. test datasets, in order to determine maximum number of vectors for use in the text feature engineering module 16, in accordance with example embodiments. The number of vectors to be applied to a particular variable value is dependent on the text size of the variable value. The algorithm begins at block 18A where a metric, i.e. statistics based algorithmic model, is selected from a grouping of postulated metrics based on a task, e.g. to estimate the correct number of for each text variable. The metric selected can be, e.g., a binary classification model, designed to determine how correlated the resulting vectors are to each other. The algorithm continues at block 18B where the metric is executed against a corpus of test datasets. The corpus of test datasets span a range of text sizes. The test dataset can be considered as text (complex string) associated with a variable value and a row identifier. Each test dataset includes text that has been cleaned, comprises multiple entries, a collection of words per entry, and comprises a number of distinct words per entry, and a combination of words. By cleaned, it is meant that certain words, such as stop words, are removed and other words in the corpus that do not satisfy a minimal occurrence setting are removed. The results of the execution produces a number of measurement variables related to each test dataset. The measurement variables can include, e.g., the variable names: dataset identifier, minimum number of words, a median correlation, a 75% quantile correlation, a 90% quantile correlation, a maximum correlation, a total count of unique words per test dataset variable, and the number of rows (entries) per test dataset variable per dataset. The size of the test dataset can be determined from associated variable values.

The algorithm continues at block 18C where the results of executing the metric against the test datasets are used to identify one or more suitable functional forms. A suitable functional form is an algorithmic model that best describes the functional relationship between data points. In this particular case, the function form is selected based on the functional form's capability of describing the relationship between a number of distinct words and a numerical range of vectors identified in the results. As an example, a logistic curve can be used to describe the dependent relationship between a number of vectors and a number of distinct words for a particular test dataset, another number of vectors and another number of distinct words for another test dataset, etc.

The algorithm continues at block 18D where the measurement variables from the results of the evaluation are fitted to each identified functional form in order to determine which function form is the algorithmic model best suited to describe the relationship between the measurement variables. The algorithm continues at block 18E where the selected function form is fitted against the test datasets in order to determine an estimate of the number of vectors. The number of vectors can be estimated by using Y=f(X,{p}), where Y=number of vectors, f=functional form, X=text corpus size, p=the parameters obtained from the curve fitting. Y, the number of vectors, is used to map segment constituent words of string variables into a set of Y numbers. The mapping is performed only for complex string structures labeled as text and generated by the algorithm for the automated detection of text variables component 14. The actual mapping occurs in the text feature engineering module 16. The original variables identified as text are stored for further use by the text explain-ability component 24.

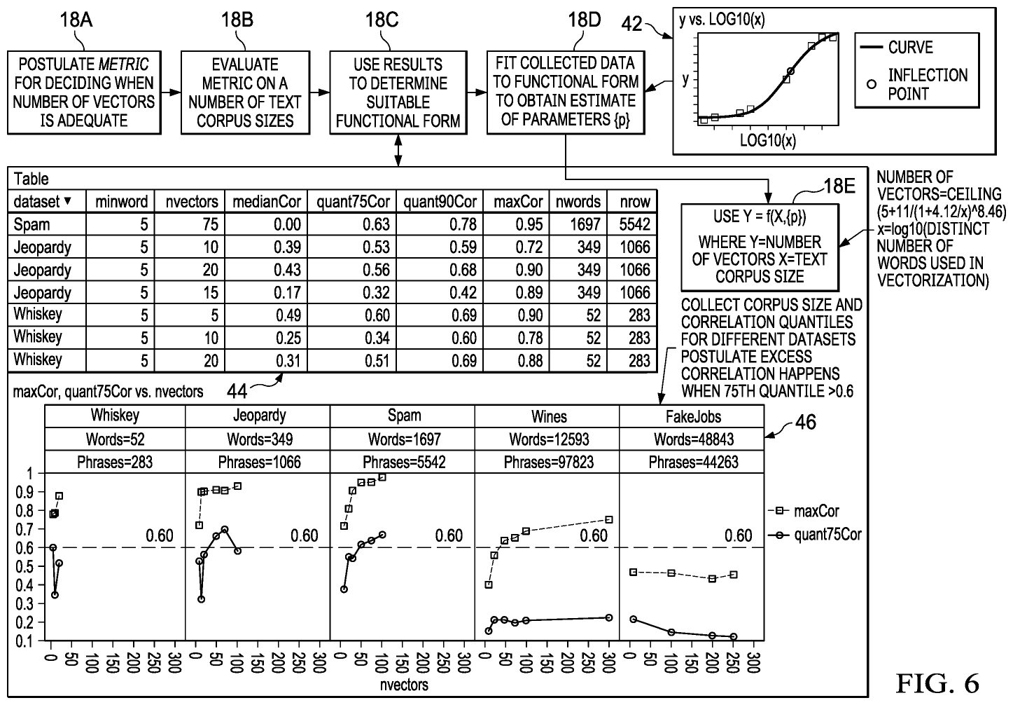

Referring now to FIG. 6, illustrated are the results of a functional form applied against multiple test datasets and used to evaluate a postulated metric, the metric used to determine a maximum number of vectors for use with the automated, hyper-parameter setting feature 18, in accordance with example embodiments. Chart 42 is an example chart comprising data points generated using a logistic curve. It should be understood that the algorithm, and in particular the output from block 18, “Evaluate Metric On A Number Text Corpus Sizes,” of the automated, hyper-parameter setting feature 18 can generate a plurality of data points that can be plotted to many different charts, depending upon the number of test data sets used and the number of functional forms generated, using logistic curve. Example calculated metrics are illustrated in table 44. Table 44 identifies the parameters: test dataset, minimum number of words, number of vectors, median Correlation, 755 quantile correlation, 90% quantile correlation, 90% quantile correlation, maximum correlation, number of words, and number of rows. The table 44 also includes the generated variable values. The variables can be used to chart the correlation vectors against the number of vectors, as illustrated in chart 46. In this particular instance, excess correlation is postulated to mean when the 75% quantile correlation variable values are greater than 0.6. It should be understood that the algorithm of the automated, hyper-parameter setting feature 18 can select from a plurality of postulations that are predetermined based on the test datasets used.

The algorithm of the text detection component 14 applies string variables, simple and complex string variables, as well as other variables, to the text feature engineering component 16, as previously discussed in reference to FIG. 3. The automated, hyper-parameter setting feature 18 causes the text feature engineering component 16 to granulate the identified variables into a vector format based on Y=f(X,{p}). Stated differently, the automated, hyper-parameter setting feature 18 causes the text feature engineering component 16 to separate a variable value identified as text into a number of vectors based on the maximum number of vectors identified by the algorithm 18.

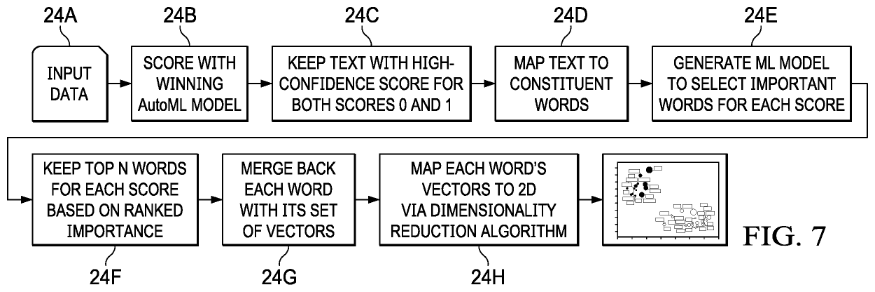

Referring now to FIG. 7, illustrated is an algorithm of the text explain-ability component 24, used to enhance the functionality of the string explain-ability component 22, for generating an explanation of the effect text variables have on predictive results of the predictive engine 20, in accordance with example embodiments. The algorithm begins at block 24A where input data, i.e. output of the predictive engine 20, is processed further.

The algorithm continues at block 24B where the algorithm selects at least one winning algorithmic model generated by the predictive engine 20. The input data is scored with this model, meaning that the output is a set of two new columns added to the dataset. The first added column is the predicted classification and the second added column is the confidence in the prediction. The confidence indicates a strength of relationship between the outcome variables and the predictor variables. At this point, every text variable from the input dataset has been turned to a set of vectors (we can denote this as being in vector form).

The algorithm continues at block 24C where the rows for which the predictive confidence is higher than a chosen threshold are selected for additional analysis. The algorithm continues at block 24D where the filtered, assembled text variables from block 24C are mapped to their constituent words, originally output in vector form from the predictive engine 20. The algorithm continues at block 24E where an algorithmic model is selected and trained against the constituent words. At block 24F, the algorithm selects the variables that have a score that satisfies a predefined threshold. The algorithm continues at block 24G wherein the selected words are associated with their original vectors. At block 24H, the algorithm maps each word in each vector to a 2D structure using a dimensionality reduction algorithm. The words in the 2D structure can then be displayed in a graphical chart.

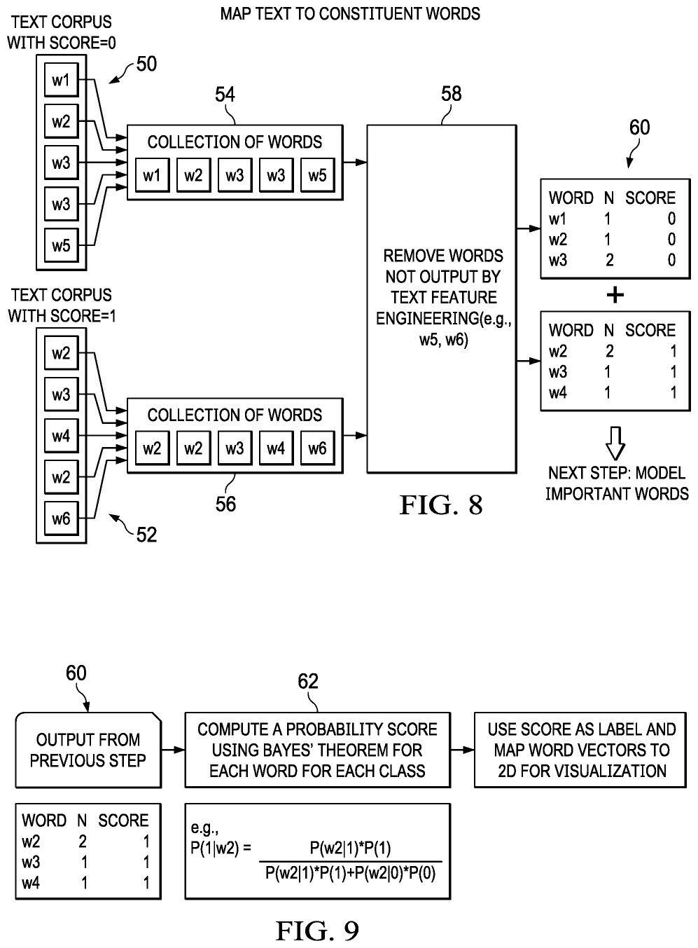

Referring now to FIG. 8, illustrated is a diagram depicting the functional features of block 24G of the text explain-ability component 24; wherein, constituent words from a classified, assembled text variable 50 having a score of 0 are mapped to a vector 54 and constituent words from another classified, assembled text variable 52 having a score of 1 are mapped to another vector 56; and then, further processed through a filter 58, in accordance with example embodiments. The filter 58 simply functions to remove words from the vectors 54, 56 that were not originally output in vector format by the text feature engineering component 16. The output 60 of the filter 58 includes a word, the number of occurrences (N) the word appears in the vector 54 and 56, and a score for each classification. It should be understood that multiple vectors may be associated with any one classified, assembled text variable. It should also be understood that the plurality of words associated with a classified, assembled text variable can be identified by the label (component of complex string variable), row number, variable name, and dataset.

Referring now to FIG. 9, illustrated is a diagram depicting functional features of block 24H of the text explain-ability component 24, in accordance with example embodiments. A probability function is applied to the output 60 for each classified, assembled text variable 50, 52. For explain-ability, a user needs to know which part of the text influenced an algorithmic model's decisions. Bayes' theorem can be used to calculate a probability that each word will appear in a given bucket, based on its prior probability of being in a bucket. The use of the term bucket here refers to a particular vector or classification. Bayes' theorem is expressed as:

$$P ( A \vert B ) = \frac{P ( B \vert A ) P ( A )}{P ( B )} ,$$

where A is the number of occurrences and B is the word.

As an example, a probability (P) can be predicted by applying Bayes' theorem on the output 60 for both classifications. An example probability score is illustrated below.

P(1|W)=P(W|1)*P(1)/(P(W|1)*P(1)+P(W|0)*P(0));

Where P(1)=Probability of word being in bucket 1=N₁/(N₁+N₀);

Where P(W|1)=Probability of the word in bucket 1=N_{word,1/}/N₁ where N_{word,1} is the frequency of word appearing in bucket 1;

Where P(0)=Probability of word being in bucket 0=N₀/N₁+N₀; and

Where P(W|0)=Probability of the word in bucket 0=N_{word,0}/N₀, where N_{word,0} is the frequency of word appearing in bucket 0.

P(1|W) is a score for bucket 1 given a word W. A score that satisfies a pre-defined threshold is a strong indicator that a particular word belongs to a particular bucket. In essence, the pre-defined threshold is a-priori information, i.e. learned behaviour, based on an algorithmic model or models, a dataset, vectors, constituent words, and probabilities that can be used to determine when a word is influential.

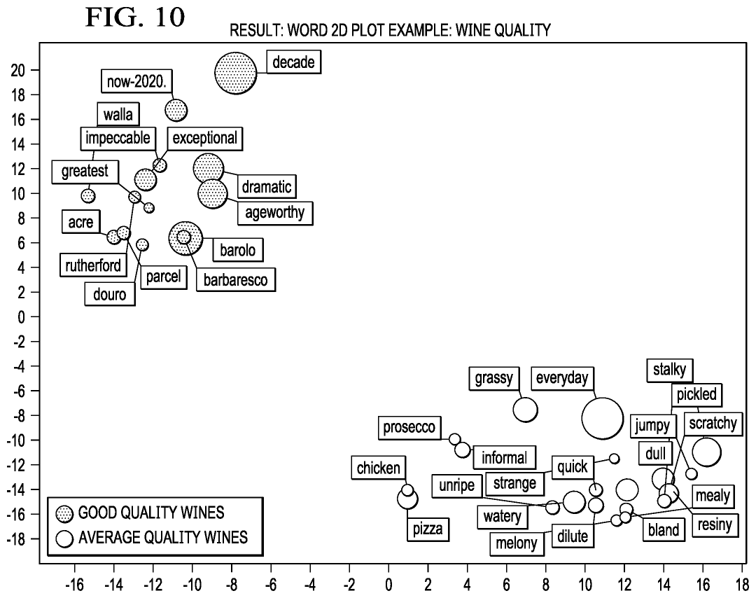

Referring now to FIG. 10, illustrated is a chart and 2D plot of words in a first vector having a first classification and words in a second vector having a second classification, wherein the words have a probability score greater than a pre-defined threshold, in accordance with example embodiments. The first classification is “Good Quality Wines” and the second classification is “Average Quality Wines.” A first cluster of words classified as “Good Quality Wines” are clustered on one side of the chart and a second cluster of words classified as “Average Quality Wines” are clustered on another side of the chart. Each word is associated with an object that has a size that is indicative of its frequency of occurrence in a vector and a color indicative of its classification. It should be understood that the cluster of words are from vectors that are associated with a string variable identified as having entries that are considered text. The values of the x and y axis are the projections of the original word vectors to two dimensions and their exact value is not relevant. What is indicative is the separation between classifications and the relative proximity of some words.

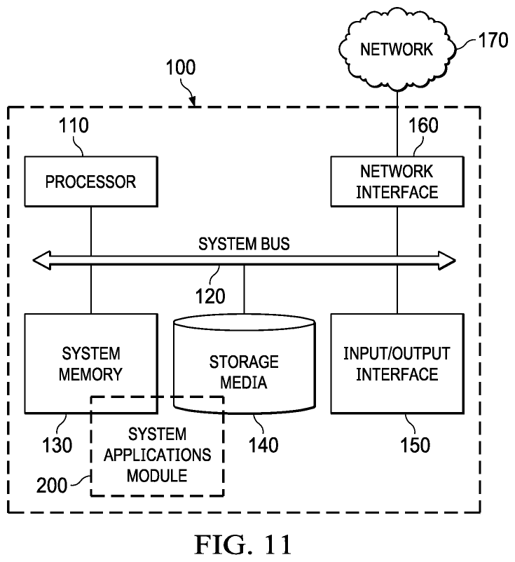

Referring now to FIG. 11, illustrated is a computing machine 100 and a system applications module 200, in accordance with example embodiments. The computing machine 100 can correspond to any of the various computers, mobile devices, laptop computers, servers, embedded systems, or computing systems presented herein. The module 200 can comprise one or more hardware or software elements designed to facilitate the computing machine 100 in performing the various methods and processing functions presented herein. The computing machine 100 can include various internal or attached components such as a processor 110, system bus 120, system memory 130, storage media 140, input/output interface 150, a network interface 160 for communicating with a network 170, e.g. a loopback, local network, wide-area network, cellular/GPS, Bluetooth, WIFI, and WIMAX.

The computing machine 100 can be implemented as a conventional computer system, an embedded controller, a laptop, a server, a mobile device, a smartphone, a wearable computer, a customized machine, any other hardware platform, or any combination or multiplicity thereof. The computing machine 100 and associated logic and modules can be a distributed system configured to function using multiple computing machines interconnected via a data network and/or bus system.

The processor 110 can be designed to execute code instructions in order to perform the operations and functionality described herein, manage request flow and address mappings, and to perform calculations and generate commands. The processor 110 can be configured to monitor and control the operation of the components in the computing machines. The processor 110 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 110 can be a single processing unit, multiple processing units, a single processing core, multiple processing cores, special purpose processing cores, co-processors, or any combination thereof. According to certain embodiments, the processor 110 along with other components of the computing machine 100 can be a software based or hardware based virtualized computing machine executing within one or more other computing machines.

The system memory 130 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 130 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 130. The system memory 130 can be implemented using a single memory module or multiple memory modules. While the system memory 130 is depicted as being part of the computing machine, one skilled in the art will recognize that the system memory 130 can be separate from the computing machine 100 without departing from the scope of the subject technology. It should also be appreciated that the system memory 130 can include, or operate in conjunction with, a non-volatile storage device such as the storage media 140.

The storage media 140 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 140 can store one or more operating systems, application programs and program modules, data, or any other information. The storage media 140 can be part of, or connected to, the computing machine. The storage media 140 can also be part of one or more other computing machines that are in communication with the computing machine such as servers, database servers, cloud storage, network attached storage, and so forth.

The applications module 200 can comprise one or more hardware or software elements configured to facilitate the computing machine with performing the various methods and processing functions presented herein. The applications module 200 can include one or more algorithms or sequences of instructions stored as software or firmware in association with the system memory 130, the storage media 140 or both. The storage media 140 can therefore represent examples of machine or computer readable media on which instructions or code can be stored for execution by the processor 110. Machine or computer readable media can generally refer to any medium or media used to provide instructions to the processor 110. Such machine or computer readable media associated with the applications module 200 can comprise a computer software product. It should be appreciated that a computer software product comprising the applications module 200 can also be associated with one or more processes or methods for delivering the applications module 200 to the computing machine 100 via a network, any signal-bearing medium, or any other communication or delivery technology. The applications module 200 can also comprise hardware circuits or information for configuring hardware circuits such as microcode or configuration information for an FPGA or other PLD. In one exemplary embodiment, applications module 100 can include algorithms capable of performing the functional operations described by the flow charts and computer systems presented herein.

The input/output (“I/O”) interface 150 can be configured to couple to one or more external devices, to receive data from the one or more external devices, and to send data to the one or more external devices. Such external devices along with the various internal devices can also be known as peripheral devices. The I/O interface 150 can include both electrical and physical connections for coupling the various peripheral devices to the computing machine or the processor 110. The I/O interface 150 can be configured to communicate data, addresses, and control signals between the peripheral devices, the computing machine, or the processor 110. The I/O interface 150 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 150 can be configured to implement only one interface or bus technology. Alternatively, the I/O interface 150 can be configured to implement multiple interfaces or bus technologies. The I/O interface 150 can be configured as part of, all of, or to operate in conjunction with, the system bus 120. The I/O interface 150 can include one or more buffers for buffering transmissions between one or more external devices, internal devices, the computing machine, or the processor 120.

The I/O interface 120 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 120 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 100 can operate in a networked environment using logical connections through the network interface 160 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The processor 110 can be connected to the other elements of the computing machine or the various peripherals discussed herein through the system bus 120. It should be appreciated that the system bus 120 can be within the processor 110, outside the processor 110, or both. According to some embodiments, any of the processors 110, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an apparatus for explaining text from predictive results generated by at least one algorithmic model, the apparatus comprising: a feature engineering module configured by a processor to: create a plurality of vectors for at least one string variable, with each string variable comprising identified text, each vector created comprising a numeric combination, each numeric combination identifying a variable name and at least one selected from a group comprising a value having a word and another value having a phrase; and cause a predictive engine to generate predictive results using the at least one algorithmic model, the data set, and the vectors created, the predictive results comprising the at least one string variable or a modified version of the at least one string variable and at least one confidence score associated with the at least one string variable or the modified version of the at least one string variable; a text explanation module configured by the processor to: map at least one selected from a group comprising words and at least one phrase from qualified text of the at least one string variable to the numeric combinations of the vectors; determine a probability score for each word and each phrase; and generate chart variables and plot variables, the plot variables comprising at least one of selected from a group comprising the most influential words and the most influential phrases, the most influential words and phrases based on the probability scores;

Clause 2, the apparatus of clause 1, further comprising a text detection module configured by a processor to: determine the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and the one or more sentences and the one or more paragraphs comprising at least one selected from a group comprising a plurality of words and at least one phrase;

Clause 3, the apparatus of clause 2, wherein the set of rules is a-priori information, the set of rules determined based on a metric, the metric defining a minimal length of text and variability of at least one selected from a group comprising words and phrases, and variable name or variable metadata;

Clause 4, the apparatus of clause 1, wherein the feature engineering module is configured by the processor to determine a number of vectors for the identified text;

Clause 5, the apparatus of clause 4, wherein the number of vectors is a-priori information, the number of vectors for the identified text determined based on at least one text corpus and a functional form;

Clause 6, the apparatus of clause 1, wherein the text explanation module is configured by the processor determine qualified text based on the at least one confidence score;

Clause 7, the apparatus of clause 1, wherein the text explanation module is configured by the processor to determine the probability score using Bayes' theorem for each word and for each phrase;

Clause 8, a system for explaining text from predictive results generated by at least one algorithmic model, the system comprising: a feature engineering module configured by a processor to: create a plurality of vectors for at least one string variable, with each string variable comprising identified text, each vector created comprising a numeric combination, each numeric combination identifying a variable name and at least one selected from a group comprising a value having a word and another value having a phrase; a predictive engine module configured by the processor to generate at least one predictive result using the at least one algorithmic model, the data set, and the vectors created, the predictive results comprising the at least one string variable or a modified version of the at least one string variable and at least one confidence score associated with the at least one string variable or the modified version of the at least one string variable; a text explanation module configured by the processor to: map at least one selected from a group comprising words and at least one phrase from qualified text of the at least one string variable to the numeric combinations of the vectors; determine a probability score for each word and each phrase; and generate chart variables and plot variables, the plot variables comprising at least one of selected from a group comprising the most influential words and the most influential phrases, the most influential words and phrases based on the probability scores;

Clause 9, the system of clause 8, wherein the predictive engine generates the at least one predictive result based on an outcome variable using the at least one algorithmic model, the at least one predictive result comprising the at least one string variable and the at least one confidence score;

Clause 10, the system of clause 8, further comprising a text detection module configured by a processor to: determine the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and the one or more sentences and the one or more paragraphs comprising at least one selected from a group comprising a plurality of words and at least one phrase;

Clause 11, the system of clause 10, wherein the set of rules is a-priori information, the set of rules determined based on a metric, the metric defining a minimal length of text and variability of at least one selected from a group comprising words and phrases, and variable names or variable metadata;

Clause 12, the system of clause 8, wherein the feature engineering module is configured by the processor to determine a number of vectors for the identified text;

Clause 13, the system of clause 12, wherein the number of vectors is a-priori information, the number of vectors for the identified text determined based on at least one text corpus and a functional form;

Clause 14, the system of clause 8, wherein the text explanation module is configured by the processor determine qualified text based on the at least one confidence score;

Clause 15, the system of clause 8, wherein the text explanation module is configured by the processor to determine the probability score using Bayes' theorem for each word and for each phrase;

Clause 16, a method for explaining text from predictive results generated by at least one algorithmic model, the method comprising: creating a plurality of vectors for at least one string variable, with each string variable comprising identified text, each vector created comprising a numeric combination, each numeric combination identifying a variable name and at least one selected from a group comprising a value having a word and another value having a phrase; generating at least one predictive result using the at least one algorithmic model, the data set, and the vectors created, the predictive results comprising the at least one string variable or a modified version of the at least one string variable and at least one confidence score associated with the at least one string variable or the modified version of the at least one string variable; mapping at least one selected from a group comprising words and at least one phrase from qualified text of the at least one string variable to the numeric combinations of the vectors; determining a probability score for each word and each phrase; and generating chart variables and plot variables, the plot variables comprising at least one of selected from a group comprising the most influential words and the most influential phrases, the most influential words and phrases based on the probability scores;

Clause 17, the method of claim 16, further comprising: determining the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and the one or more sentences and the one or more paragraphs comprising at least one selected from a group comprising a plurality of words and at least one phrase;

Clause 18, the method of clause 16, further comprising determining a number of vectors for the identified text;

Clause 19, the method of clause 16, further comprising determining qualified text based on the at least one confidence score; and

Clause 20, the method of clause 16, further comprising determining the probability score using Bayes' theorem for each word and for each phrase.

What is claimed is:

1. An apparatus for explaining text from predictive results generated by at least one algorithmic model, the apparatus comprising:
a feature engineering module configured by a processor to:
create a plurality of vectors for at least one string variable, with each string variable comprising identified text, each vector created comprising a numeric combination, each numeric combination identifying a variable name and at least one selected from a group comprising a value having a word and another value having a phrase; and
cause a predictive engine to generate predictive results using the at least one algorithmic model, the data set, and the vectors created, the predictive results comprising the at least one string variable or a modified version of the at least one string variable and at least one confidence score associated with the at least one string variable or the modified version of the at least one string variable;
a text explanation module configured by the processor to:
map at least one selected from a group comprising words and at least one phrase from qualified text of the at least one string variable to the numeric combinations of the vectors;
determine a probability score for each word and each phrase; and
generate chart variables and plot variables, the plot variables comprising at least one of selected from a group comprising the most influential words and the most influential phrases, the most influential words and phrases based on the probability scores.

2. The apparatus of claim 1, further comprising a text detection module configured by a processor to:
determine the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and
the one or more sentences and the one or more paragraphs comprising at least one selected from a group comprising a plurality of words and at least one phrase.

3. The apparatus of claim 2, wherein the set of rules is a-priori information, the set of rules determined based on a metric, the metric defining a minimal length of text and variability of at least one selected from a group comprising words and phrases, and variable names or variable metadata.

4. The apparatus of claim 1, wherein the feature engineering module is configured by the processor to determine a number of vectors for the identified text.

5. The apparatus of claim 4, wherein the number of vectors is a-priori information, the number of vectors for the identified text determined based on at least one text corpus and a functional form.

6. The apparatus of claim 1, wherein the text explanation module is configured by the processor determine qualified text based on the at least one confidence score.

7. The apparatus of claim 1, wherein the text explanation module is configured by the processor to determine the probability score using Bayes' theorem for each word and for each phrase.

8. A system for explaining text from predictive results generated by at least one algorithmic model, the system comprising:
a feature engineering module configured by a processor to:
create a plurality of vectors for at least one string variable, with each string variable comprising identified text, each vector created comprising a numeric combination, each numeric combination identifying a variable name and at least one selected from a group comprising a value having a word and another value having a phrase;
a predictive engine module configured by the processor to:
generate at least one predictive result using the at least one algorithmic model, the data set, and the vectors created, the predictive results comprising the at least one string variable or a modified version of the at least one string variable and at least one confidence score associated with the at least one string variable or the modified version of the at least one string variable;
a text explanation module configured by the processor to:
map at least one selected from a group comprising words and at least one phrase from qualified text of the at least one string variable to the numeric combinations of the vectors;
determine a probability score for each word and each phrase; and
generate chart variables and plot variables, the plot variables comprising at least one of selected from a group comprising the most influential words and the most influential phrases, the most influential words and phrases based on the probability scores.

9. The system of claim 8, wherein the predictive engine generates the at least one predictive result based on an outcome variable using the at least one algorithmic model, the at least one predictive result comprising the at least one string variable and the at least one confidence score.

10. The system of claim 8, further comprising a text detection module configured by a processor to:
determine the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and
the one or more sentences and the one or more paragraphs comprising at least one selected from a group comprising a plurality of words and at least one phrase.

11. The system of claim 10, wherein the set of rules is a-priori information, the set of rules determined based on a metric, the metric defining a minimal length of text and variability of at least one selected from a group comprising words and phrases, and variable names or variable metadata.

12. The system of claim 8, wherein the feature engineering module is configured by the processor to determine a number of vectors for the identified text.

13. The system of claim 12, wherein the number of vectors is a-priori information, the number of vectors for the identified text determined based on at least one text corpus and a functional form.

14. The system of claim 8, wherein the text explanation module is configured by the processor determine qualified text based on the at least one confidence score.

15. The system of claim 8, wherein the text explanation module is configured by the processor to determine the probability score using Bayes' theorem for each word and for each phrase.

16. A method for explaining text from predictive results generated by at least one algorithmic model, the method comprising:
creating a plurality of vectors for at least one string variable, with each string variable comprising identified text, each vector created comprising a numeric combination, each numeric combination identifying a variable name and at least one selected from a group comprising a value having a word and another value having a phrase;
generating at least one predictive result using the at least one algorithmic model, the data set, and the vectors created, the predictive results comprising the at least one string variable or a modified version of the at least one string variable and at least one confidence score associated with the at least one string variable or the modified version of the at least one string variable;
mapping at least one selected from a group comprising words and at least one phrase from qualified text of the at least one string variable to the numeric combinations of the vectors;
determining a probability score for each word and each phrase; and
generating chart variables and plot variables, the plot variables comprising at least one of selected from a group comprising the most influential words and the most influential phrases, the most influential words and phrases based on the probability scores.

17. The method of claim 16, further comprising:
determining the identified text, the identified text determined based on at least one selected from a group comprising a set of rules and a minimal confidence score, the identified text having at least one variable name associated with a variable of the data set and a variable value comprising at least one selected from a group comprising one or more sentences and one or more paragraphs; and
the one or more sentences and the one or more paragraphs comprising at least one selected from a group comprising a plurality of words and at least one phrase.

18. The method of claim 16, further comprising determining a number of vectors for the identified text.

19. The method of claim 16, further comprising determining qualified text based on the at least one confidence score.

20. The method of claim 16, further comprising determining the probability score using Bayes' theorem for each word and for each phrase.
